(19) United States
(12) Patent Application Publication
(10) Pub. No.: US 2018/0320808 A1
(43) Pub. Date: Nov. 8, 2018

(54) QUICK-ACTING, INVIOLABLE AND LEAKTIGHT FASTENING SYSTEM WITH RIBBED OUTER SEAL

(71) Applicant: GESTWAY - GESTÄO DE INFRA ESTRUTURAS LTDA, São Paulo (BR)

(72) Inventor: José Henrique MESSIAS, Sumaré (BR)

(73) Assignee: GESTWAY - GESTÄO DE INFRA ESTRUTURAS LTDA, São Paulo (BR)

(21) Appl. No.: 15/773,845

(22) PCT Filed: Nov. 7, 2016
(86) PCT No.: PCT/BR2016/050282

§ 371 Date: May 4, 2018

(30) Foreign Application Priority Data
Nov. 6, 2015 (BR) 10 2015 028035 1

(51) Int. Cl. F16L 37/091; F16L 21/02; F16L 13/00

(52) U.S. Cl. CPC F16L 37/091; F16L 13/002; F16L 21/02

(57) ABSTRACT

A system that uses the male-female coupling concept, by mechanical interference between the serrated toothing on the parts to be fastened permanently together or by way of a sleeve-like couplings, but not before sealing elements which satisfy the IP 68 rating are placed therebetween. The outermost, female part or the sleeve-like couplings have particularly elastic peripheral ribs which allow them to expand sufficiently to fit the serrated toothing, such that the mounting can only be undone by cutting the rib, thus characterizing the violation of the sleeve-like coupling or of the outermost female part having a complex profile, used in the fastening system.

The present request is an application for patent of invention of a new QUICK-ACTING, INVIOLABLE AND LEAKTIGHT FASTENING SYSTEM WITH RIBBED OUTER SEAL, referring to a system which uses as a fastening means the mechanical interference caused by the fitting of serrated toothing of the parts to be joined, which together with specific seals and external ribs functioning as a seal attribute the characteristics of inviolability and leak-tightness to the system in any product in which it is applied. Disengagement between the parts is only possible with the rupture and/or breaking of at least one rib, which relieves pressure between the serrated toothing, and therefore releases the coupling or the external part.

### FIELD OF APPLICATION

The invention is preferably applied to the hydraulics segment, more specifically the joint sleeve, but not limited to that product, which can be used, for example, in pipes of the same diameter or not, between a device and a tubing, for piping capping, for coupling hydrometers with hydraulic grid, for coupling devices with complex contour joints provided they have compatible serrated toothing and ribs as external seal.

### Current State of the Art

The known fastening systems do not concomitantly contemplate the amplitude of the proposed system in terms of the possibilities of applications, degree of protection against fraud, inviolability and leak-tightness. In this context, the products in which the known fastening system is used have specific applications. Thus, to better define, a sleeve serves only to make the union of two tubes, either by means of thread or chemical taping with all the limitations inherent in these fastening processes, including the use of tools, the time consumption, skilled labor, the compatibility of the geometries of the surfaces to be joined/fastened, etc.

The current state of the art has developed some quick couplings, which, in theory, make pipe assemblies more practical:

DOCUMENT: PI 0205006-4—TITLE—IMPROVEMENTS IN QUICK COUPLING DEVICE FOR PIPES. It is notable for the fact that the tips of the pipes create areas where a smaller diameter recess is arranged between two contours with equal diameters, but slightly larger than the previous one. One of the contours, the inner side, adjacent to the outer diameter of the pipe receives the application of a glue, so that the fastening of the sleeve or ring is more efficient, whereas the smaller diameter recess serves as a housing for a resilient bellows-like element (rubber), whose diameter is compatible with the outer diameter of said pipe.

Despite being a quick fitting, it still requires the use of chemical taping which requires certain time and qualification of the one performing it. In addition, the application of the connection is very specific, that is, it is focused on coupling pipes, and if disjointed, it leaves no type of evidence, therefore different from the application requested here.

DOCUMENT: M U 7801234-1—TITLE—QUICK COUPLING ARRANGEMENT It comprises a male tip with a weldable pouch and a female tip also with a weldable pouch mountable in the former. The male tip consists of a tubular body, a weldable sleeve and an externally-threaded sleeve assembled with one another. The female tip comprises a stepped tubular body provided at one end with an internally-threaded glove-shaped insert of injected plastic material, and at the opposite end having a smaller diameter, said stepped tubular body defines a welding pouch.

As can be seen, the aforementioned provision is complex and cannot bring together in a single product the characteristics of inviolability, fraud prevention and application diversity (fastening of parts with complex formats).

### Objectives of the Invention

The objective of the present invention is therefore to propose a quick fastening system which simultaneously contemplates the characteristics of inviolability, leak-tightness (IP68), fraud prevention and application diversity with the possibility of use in hydraulic couplings and parts of complex shapes.

A further objective of the invention is to propose a system which applied to a product evidences fraud by rupture/breaking of the rib/seal.

A further objective of the invention is to propose a system that applied to a product does not require tools and special skills for assembly and fastening of the parts that occurs manually and without chemical taping or threading.

### The Invention

Basically, the invented system adds the characteristics of inviolably, degree of IP68 sealing, ease and low stress in the coupling/fastening of the parts and diversity of applications, since it unites concept of coupling/fastening of the male and female type by mechanical interference through the coupling of the serrated toothing of said parts to be permanently fastened, not without first receiving among them sealing elements that meet the IP68 tightness degree. Although the serrated toothing fit by mechanical interference, there is no need for tools, but only manual pressing. In the surroundings of the part with the female-type fitting, that is, the external part has perimeter ribs having sealing function. These ribs dilate plastically enough for the serrated toothing of the male part to enter the serrated toothing of the female part, returning to the initial position soon after the assembly takes place. The disassembly by the proposed system will only occur with the breaking of one of the ribs, which will relieve the pressure of the external female part. The female part may also be represented by a sleeve joint coupling.

### DESCRIPTION OF THE DRAWINGS

For better visualization of the invented system and its application, the drawings listed below are attached in an illustrative and non-limiting way:

FIG. 1: Sectional side view of the quick-acting, inviolable and leaktight fastening system with ribbed outer seal applied to a sleeve-like coupling, coupling two piping parts;

FIG. 2: Side exploded-sectional view of the quick-acting, inviolable and leaktight fastening system with ribbed outer seal applied to a sleeve-like coupling, coupling two piping parts;

FIG. 3: Perspective view of the sleeve-like coupling using the quick-acting, inviolable and leaktight fastening system with ribbed outer seal;

FIG. 4: Side sectional view of the sleeve-like coupling using the quick-acting, inviolable and leaktight fastening system with ribbed outer seal;

FIG. 5: Front view of the sleeve-like coupling using the quick-acting, inviolable and leaktight fastening system with ribbed outer seal;

FIG. 6: Sectional side view of the quick-acting, inviolable and leaktight fastening system with ribbed outer seal applied to the fastening of two pieces with complex contour coupling parts;

FIG. 7: Perspective view of the quick-acting, inviolable and leaktight fastening system with ribbed outer seal applied to the fastening of two pieces with complex contour coupling parts;

FIG. 8: Exploded-perspective view of the quick-acting, inviolable and leaktight fastening system with ribbed outer seal applied to the fastening of two pieces with complex contour coupling parts;

FIG. 9: Sectional side view of the quick-acting, inviolable and leaktight fastening system with ribbed outer seal applied to the fastening of a pipe with complex contour coupling parts;

FIG. 10: Perspective view of the quick-acting, inviolable and leaktight fastening system with ribbed outer seal applied to the fastening of a pipe with complex contour coupling parts;

FIG. 11: Exploded-perspective view of the quick-acting, inviolable and leaktight fastening system with ribbed outer seal applied to the fastening of a pipe with complex contour coupling parts.

### TECHNICAL DESCRIPTION

The QUICK-ACTING, INVIOLABLE AND LEAKTIGHT FASTENING SYSTEM WITH RIBBED OUTER SEAL, object of this invention, consists of a system using the male-female coupling concept, by mechanical interference, by the engagement of the serrated toothing (1 and 2) of the parts (A and B) to be directly and permanently fastened or by means of sleeve-like coupling (3), not without first receiving between them sealing elements (4) which meet the IP68 degree, the outermost female part (A) or sleeve-like coupling (3) having particularly elastic perimeter ribs (5), which allow their sufficient dilatation for the engagement of said serrated toothing (1 and 2) (5), thus characterizing the violation of the sleeve-like coupling (3) or the outermost complex contour female part using the fastening system.

More particularly, the invention refers to a quick-acting inviolable and leaktight fastening system since a light manual pressing is all is needed for permanent coupling between the parts (A and B), whether using a sleeve-like coupling (3) or even directly between said parts (A and B), wherein the system consists of the concept of male and female type fitting between the serrated toothing (1 and 2), whose measurements impart a mechanical interference which makes it impossible to naturally remove or dismantle the sleeve-like coupling (3) or parts (A and B).

Sealing elements (4), that meet the IP68 degree of tightness, are strategically positioned on the contact and/or coupling surfaces which may leak. Therefore, one fastened, the assembly will be tight and free of leaks. On the outer side of the sleeve-like coupling (3) or the female part (A) one can observe perimeter ribs (5) having sealing function.

The ribs (5) have the same wall thickness as the sleeve-like coupling (3) or the part (A) and contain an opening (6) which enables their sufficient plastic expansion for the serrated toothing (1 and 2) to overlap and return to the starting position immediately after the assembly is complete. Thereby, the inviolability of the sleeve-like coupling (3) and the parts (A and B) is characterized until the evidence, which is clear with the cut of the rib (5); in fact, otherwise it will not be possible to dismantle the system proposed. Said cut will relieve the pressure of the female part (A) on the male part (B) or the sleeve-like coupling (3) on the male part (B) which may be a pipe of any section or even a complex design coupling, for example.

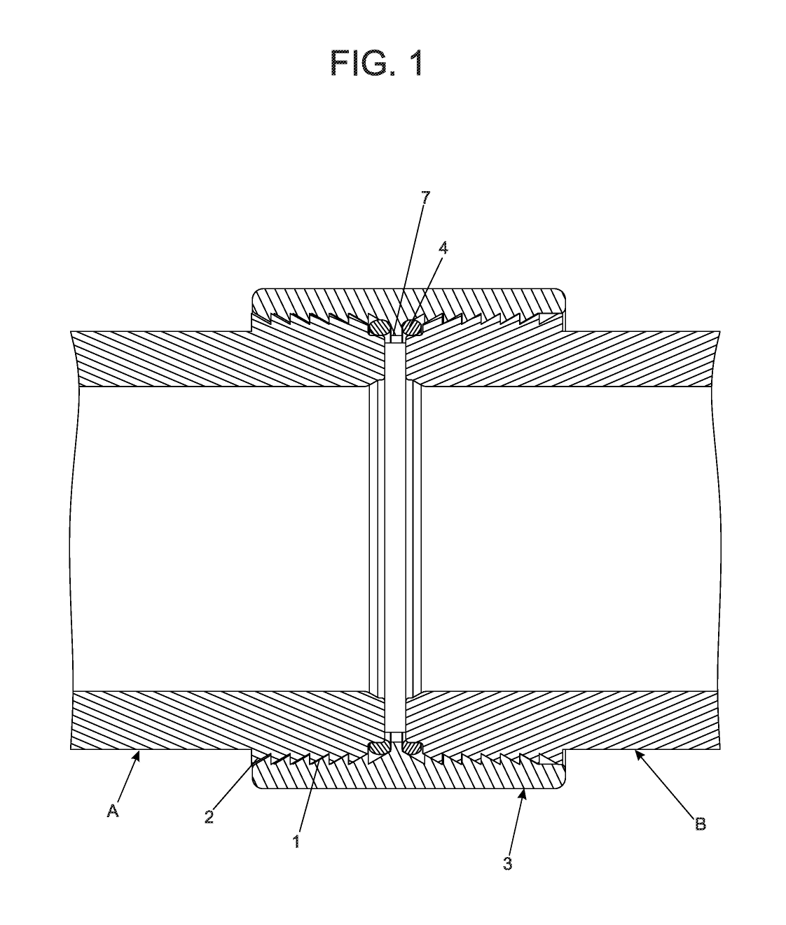

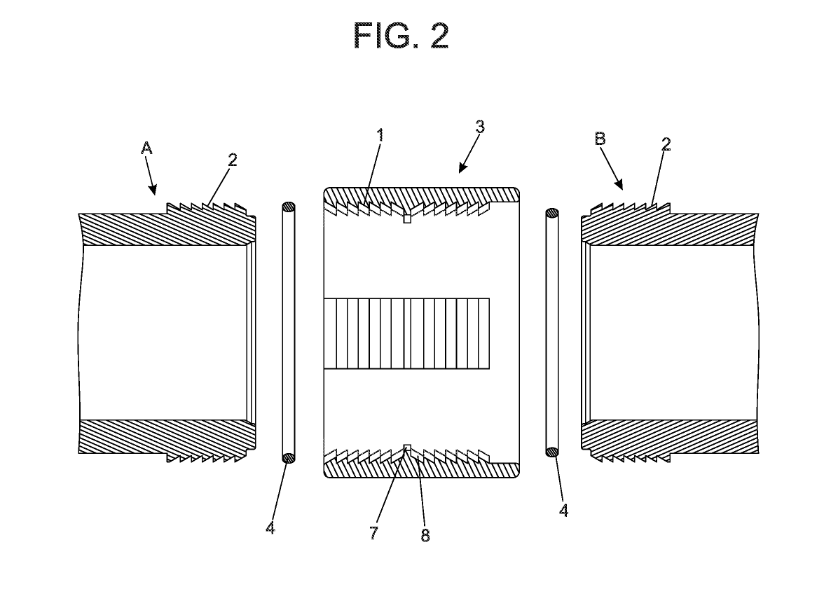

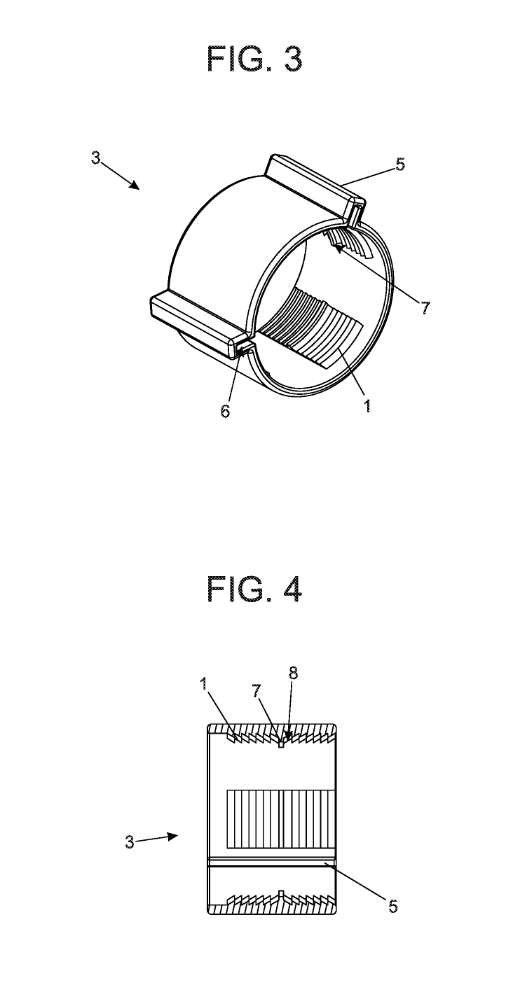

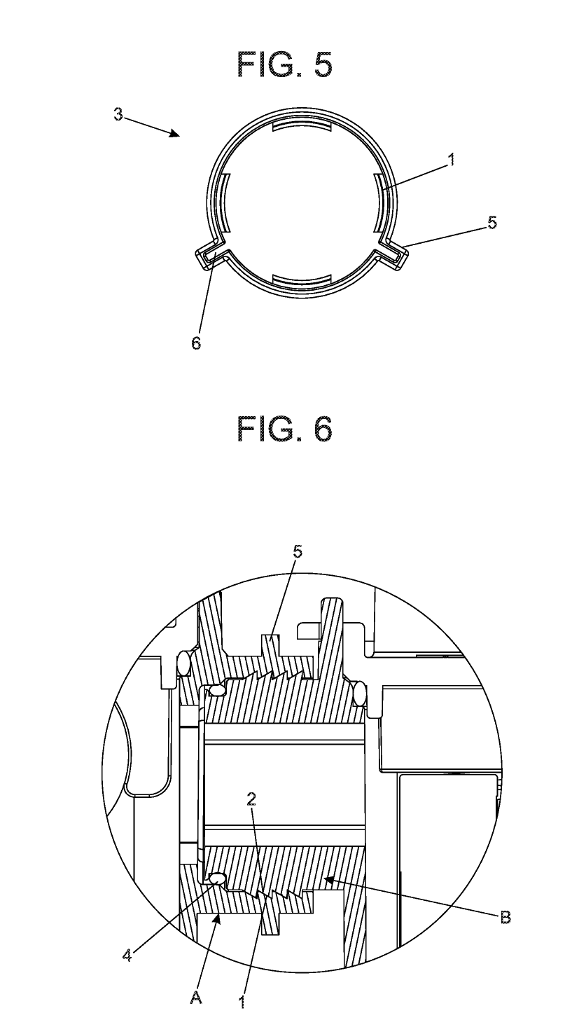

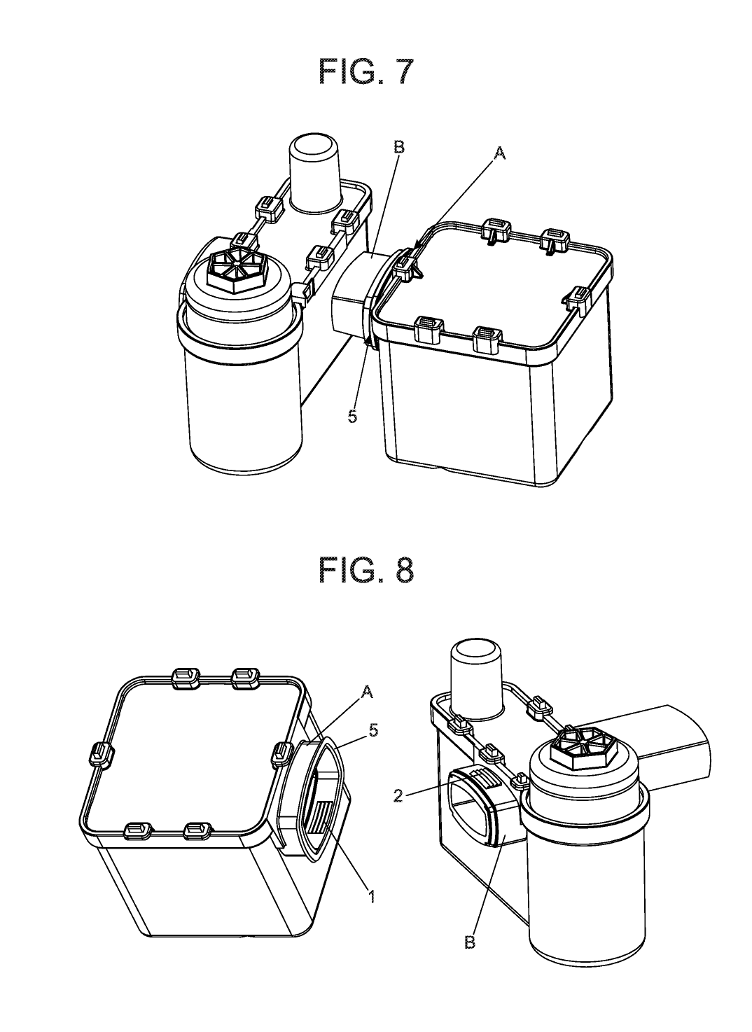

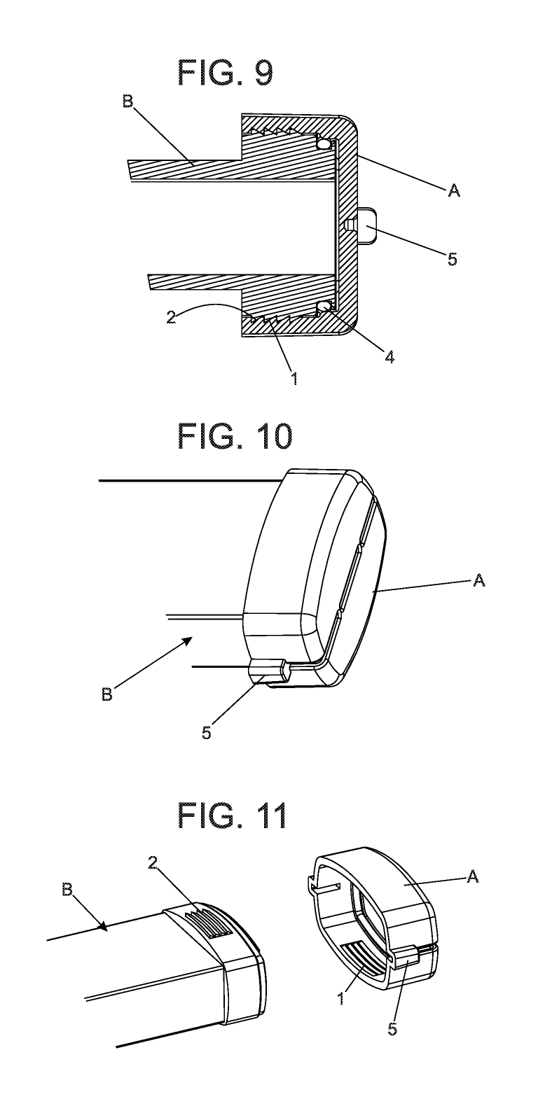

Therefore, the system may be applied to a sleeve-like coupling (3) as shown in FIGS. 1 and 2, where one can note a stop (7) followed by a relief ramp (8). Moreover, as shown in FIGS. 6, 7 and 8, the same concept can be applied in pieces having complex coupling parts (A and B) in which the female coupling part (A) is external to the male coupling part (B). Finally, as shown in FIGS. 9, 10 and 11, the system can be applied to complex design tubular elements whose end represents the male coupling part (B) and the capping means represents the female coupling part (A) with ribs (5).

1-4. (canceled)

5. A quick-acting, inviolable and leaktight fastening system with ribbed outer seal, comprising:
a permanent manual, inviolable, and leaktight fastening between two parts either with the use of a sleeve-like coupling or even directly between the parts with a male-female coupling between serrated toothing whose mechanical interference makes it impossible to remove or dismantle the sleeve-like coupling or the parts; further comprising an outermost female part or sleeve-like coupling having particularly elastic perimeter ribs, the assembly being undone only by cutting the said rib, thereby characterizing violation; further comprising sealing elements, that meet the IP68 degree of tightness, and are positioned on the contact and/or coupling surfaces which may leak.

6. The quick-acting, inviolable and leaktight fastening system with ribbed outer seal, according to claim 5, wherein the sleeve-like coupling has internal serrated toothing, a stop followed by a relief ramp and, externally, the ribs having a sealing function.

7. The quick-acting, inviolable and leaktight fastening system with ribbed outer seal, according to claim 5, wherein it is applied in pieces with complex coupling parts, wherein the female coupling part, with serrated toothing and ribs, is external to the male coupling part with serrated toothing, in addition to the strategically positioned sealing elements.

8. The quick-acting, inviolable and leaktight fastening system with ribbed outer seal, according to claim 5, wherein it is applied in complex design tubular elements whose end represent the male coupling part with serrated toothing, and a capping means represents the female coupling part, with serrated toothing and ribs.
